(19) United States
(12) Patent Application Publication
(10) Pub. No.: US 2016/0092596 A1
(43) Pub. Date: Mar. 31, 2016

(54) DATABASE MIGRATION METHOD AND APPARATUS

(71) Applicant: SAMSUNG SDS CO., LTD., Seoul (KR)

(72) Inventors: Jae Hong KIM, Seoul (KR); Jae Young LEE, Seoul (KR); Young Sun WON, Seoul (KR)

(73) Assignee: SAMSUNG SDS CO., LTD., Seoul (KR)

(21) Appl. No.: 14/587,823

(22) Filed: Dec. 31, 2014

(30) Foreign Application Priority Data
Sep. 26, 2014 (KR) 10-2014-0129311

(51) Int. Cl. G06F 17/30

(52) U.S. Cl. CPC G06F 17/30958; G06F 17/30914; G06F 17/3051

(57) ABSTRACT

A method for migrating data from a relational DB to a graph DB comprises, collecting constraints of referencing tables having a column set as a foreign key, among tables of a relational DB which is a migration source DB, determining a relation type of each of the referencing tables, based on constraints of the referencing table, determining a node generation target table and a relation frame for each of the referencing tables, based on the relation type of the referencing table, and converting data in each row of the node generation target table into a node of a graph DB which is a migration target DB and generating a relation of the graph DB, which connects the generated nodes, according to the relation frame.

This application claims priority from Korean Patent Application No. 10-2014-0129311 filed on Sep. 26, 2014 in the Korean Intellectual Property Office, the disclosure of which is incorporated herein by reference in its entirety.

### BACKGROUND OF THE INVENTION

1. Field of the Invention

The present invention relates to a database (DB) migration method and apparatus, and more particularly, to a method and apparatus for migrating data from a relational DB to a graph DB.

2. Description of the Related Art

Database (DB) migration is the process of transferring data recorded in a DB of a first format to a DB of a second format.

A relational DB is a collection of data items in the form of a series of standardized tables. The data can be accessed or combined in various ways without the need for reconfiguring DB tables. A lot of data are being managed in the relational DB.

A graph DB manages data by defining relations among entities. There is a growing interest in the graph DB in which associative information between data (e.g., data for social network service) can be found rapidly. One widely known advantage of the graph DB is that desired information that can be found through a number of join operations in the relational DB can be found easily in the graph DB.

In the case of a service having similar requirements to those of the service of finding the associative relationship between data, it is required to move data stored in the relational DB to the graph DB in order for easier and faster data search. However, a technology for automatically migrating data from the relational DB to the graph DB has not been provided yet.

### SUMMARY OF THE INVENTION

Aspects of the present invention provide a method and apparatus for automatically migrating data from a relational database (DB) to a graph DB.

However, aspects of the present invention are not restricted to the one set forth herein. The above and other aspects of the present invention will become more apparent to one of ordinary skill in the art to which the present invention pertains by referencing the detailed description of the present invention given below.

In some embodiments, a database (DB) migration method comprises, collecting constraints of referencing tables having a column set as a foreign key, among tables of a relational DB which is a migration source DB, determining a relation type of each of the referencing tables, based on constraints of the referencing table, determining a node generation target table and a relation frame for each of the referencing tables, based on the relation type of the referencing table, and node generation target table into a node of a graph DB which is a migration target DB and generating a relation of the graph DB, which connects the generated nodes, according to the relation frame.

In some embodiments, a DB migration apparatus comprises a constraint collection unit which collects constraints of referencing tables having a column set as a foreign key among tables of a relational DB which is a migration source DB, a relation type determination unit which determines a relation type of each of the referencing tables based on constraints of the referencing table, a node and relation determination unit which determines a node generation target table and a relation frame for each of the referencing tables based on the relation type of the referencing table, and a graph DB generation unit which converts data in each row of the node generation target table into a node of a graph DB which is a migration target DB and generates a relation of the graph DB, which connects the generated nodes, according to the relation frame.

In some embodiments, A non-transitory computer readable storage medium storing a computer program, said program causing a computer to, collect constraints of referencing tables having a column set as a foreign key among tables of a relational DB which is a migration source DB, determine a relation type of each of the referencing tables based on constraints of the referencing table, determine a node generation target table and a relation frame for each of the referencing tables based on the relation type of the referencing table, and convert data in each row of the node generation target table into a node of a graph DB which is a migration target DB and generate a relation of the graph DB, which connects the generated nodes, according to the relation frame.

### BRIEF DESCRIPTION OF THE DRAWINGS

The above and other aspects and features of the present invention will become more apparent by describing in detail exemplary embodiments thereof with reference to the attached drawings, in which:

FIG. 1 is a conceptual diagram of a graph database (DB);

FIG. 2 illustrates five relation types among entities in a relational DB;

FIG. 3 is a flowchart illustrating a DB migration method according to an embodiment of the present invention;

FIG. 4 is an example of a query inputted to obtain constraints according to an embodiment of the present invention;

FIG. 5 is an example of data output as a result of the input of the query illustrated in FIG. 4;

FIG. 6 is a flowchart illustrating a partial operation of FIG. 3 in detail;

FIG. 7 is a table illustrating a method of generating a node and a relation for each relation type;

FIGS. 8 through 10 illustrate an embodiment in which an exception is made to the node and relation generation method of FIG. 7 in some relation types;

FIG. 11 is a diagram illustrating the relationships between tables of a relational DB that are to be migrated to a graph DB according to embodiments of the present invention;

FIGS. 12A through 12G illustrate row data input to the tables shown in the diagram of FIG. 11;

FIG. 13 is an example of data output as a result of the input of a query for obtaining constraints to the relational DB of FIGS. 11 through 12G;

FIG. 14 is a table illustrating the relation type, node generation target table, and relation frame of each referencing table of FIG. 13;

FIG. 15 illustrates a node list and a relation list generated by collecting a node generation target table and a relation frame for each referencing table of FIG. 14;

FIG. 16 illustrates a graph DB to which data of the relational DB of FIGS. 11 through 12G has been migrated;

FIG. 17 is a flowchart illustrating a DB migration method according to another embodiment of the present invention;

FIG. 18 is an example of a node property and label setting user interface (UI) according to an embodiment of the present invention;

FIG. 19 is an example of a relation property and label setting UI according to an embodiment of the present invention;

FIG. 20 illustrates the configuration of a DB migration system according to an embodiment of the present invention;

FIG. 21 is a block diagram of a DB migration apparatus according to an embodiment of the present invention; and

FIG. 22 illustrates the hardware configuration of a DB migration apparatus according to another embodiment of the present invention.

### DETAILED DESCRIPTION OF THE INVENTION

Advantages and features of the present invention and methods of accomplishing the same may be understood more readily by reference to the following detailed description of preferred embodiments and the accompanying drawings. The present invention may, however, be embodied in many different forms and should not be construed as being limited to the embodiments set forth herein. Rather, these embodiments are provided so that this disclosure will be thorough and complete and will fully convey the concept of the invention to those skilled in the art, and the present invention will only be defined by the appended claims. Like reference numerals refer to like elements throughout the specification.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Before describing embodiments of the present invention, relation types among entities in a graph database (DB) and a relational DB will be described.

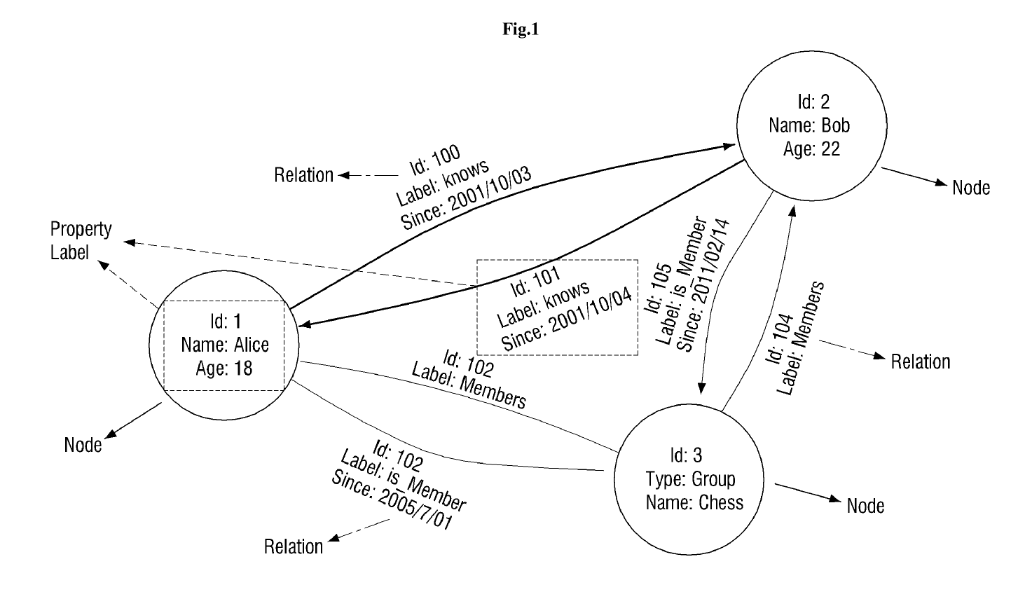

FIG. 1 is a conceptual diagram of a graph DB. Referring to FIG. 1, the graph DB adopts the concept of a graph. Thus, the graph DB consists of nodes, each indicating data, and relations, each indicating the relationship between data. One node in the graph DB denotes each row of each table in a relational DB. Data contained in one node is represented by properties. For example, properties of a node shown on the left side of FIG. 1 are ID, name, and age. Each node may also have a label. A relation connects nodes. The relation connecting the nodes may have directionality. Like a node, the relation may have properties.

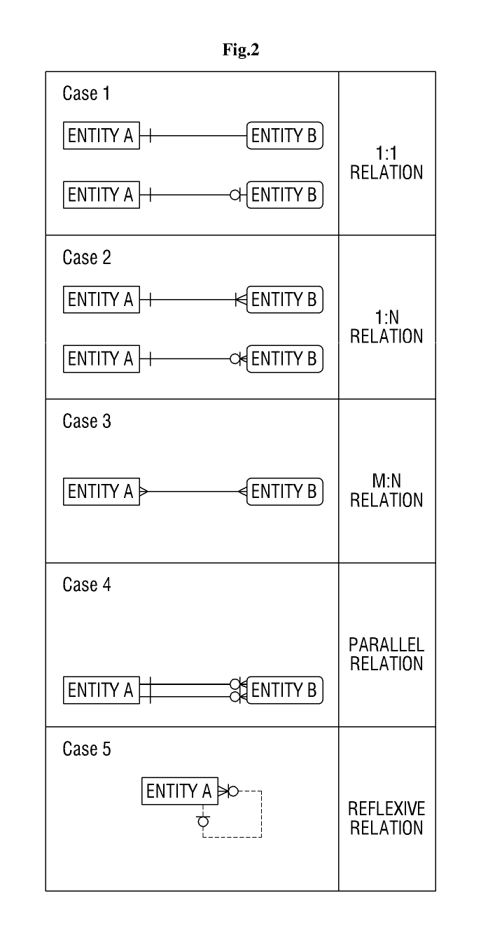

FIG. 2 illustrates five relation types among entities in a relational DB. Entities shown in FIG. 2 can be understood as tables in the relational DB. Referring to FIG. 2, five relation types may exist among entities in the relational DB. The five relation types will now be described below.

A 1:1 relation is a relation in which table A and table B have the same column as a primary key. For example, table A may be basic user information, and table B may be additional user information. In this case, table A and table B may have the 1:1 relation.

A 1:N relation is a relation in which table B references a primary key of table A as a foreign key. For example, table A may be department information, and table B may be employee information. In this case, table A and table B may have the 1:N relation.

An M:N relation is a relation in which table A and table B are connected by an intermediate relation-defining table that references primary keys of both table A and table B. For example, table A may be product information, and table B may be customer information, and table C may be order information. In this case, table A and table B may have the M:N relation.

A parallel relation is a relation in which two or more columns of table B reference a primary key of table A as foreign keys. For example, table A may be branch management data, table B may be account management data, and two foreign keys (e.g., an account opening branch code column and an account managing branch code column) that reference a primary key (e.g., branch ID) of table A may exist in table B. In this case, table A and table B may have the parallel relation.

A reflexive relation is a relation in which a column of table A references a primary key of table A as a foreign key. For example, table A may be employee data and may include an employee number column and a manager's employee number column. In this case, if the manager's employee number column is a foreign key that references the employee number column, table A has the reflexive relation.

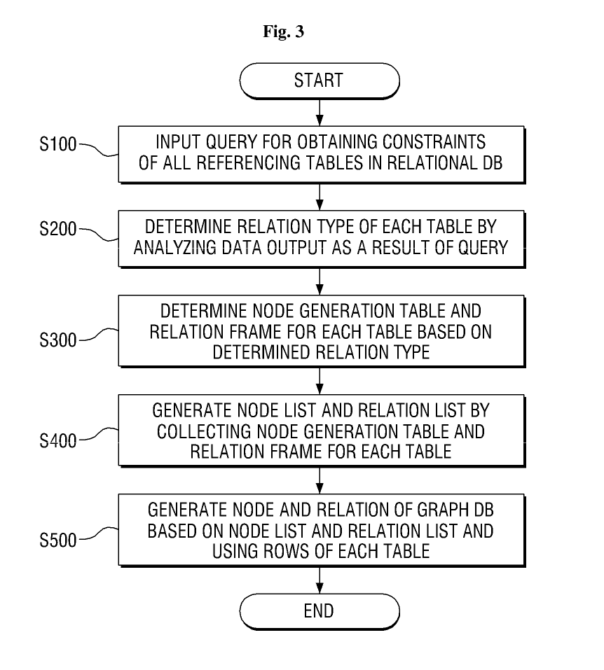

A DB migration method according to an embodiment of the present invention will now be described with reference to FIG. 3. The current embodiment may be performed by a computing device including an operation unit. The computing device may be, for example, a DB migration apparatus according to another embodiment of the present invention. The configuration and operation of the DB migration apparatus will be described in detail later. For ease of description, a subject that performs each operation of the DB migration method according to the current embodiment will be omitted.

First, referencing tables having a column set as a foreign key are selected from tables of a relational DB which is a migration source DB, and constraints of the referencing tables are collected. In an embodiment, a query for obtaining constraints of all referencing tables in the relational DB may be generated and input to a DB management system (DBMS) of the relational DB (operation S100).

According to an embodiment, constraints of all referencing tables having a column set as a foreign key among the tables of the relational DB may be collected using the query, and migration may be performed using the collected constraints.

According to another embodiment, constraints of some of the referencing tables having a column set as a foreign key among the tables of the relational DB may be collected using the query, and migration may be performed using the collected constraints. That is, of the tables of the relational DB, tables that do not need to be reflected in the migration operation may be excluded in advance from target tables whose constraints are to be collected.

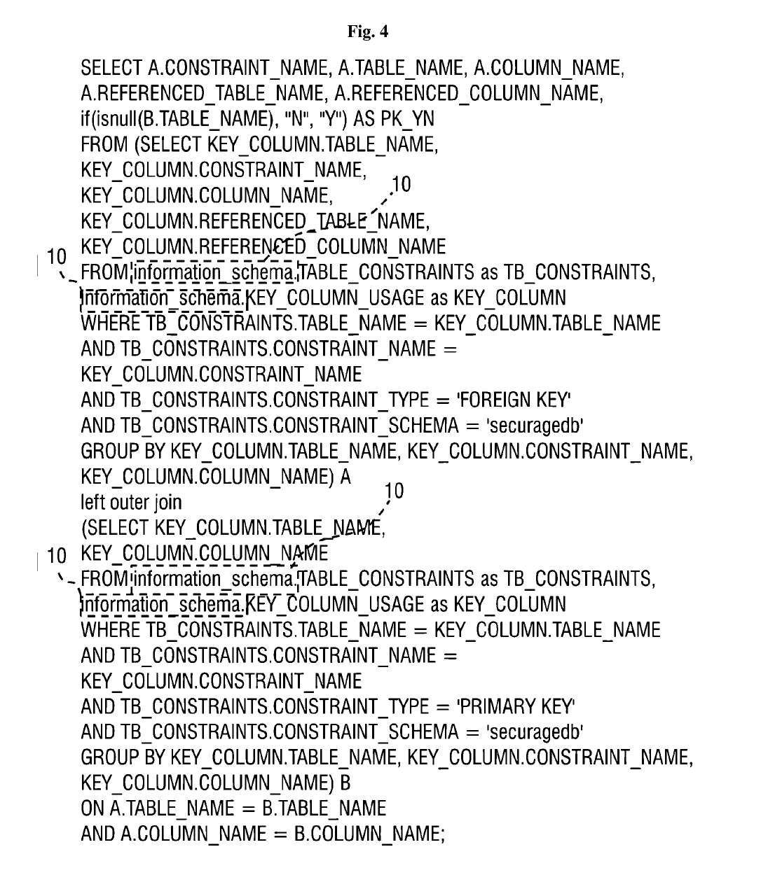

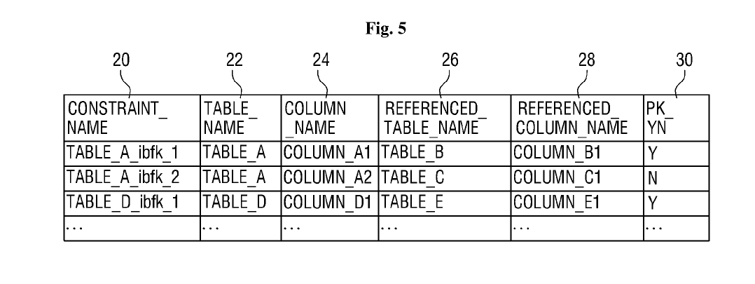

FIG. 4 is an example of the query of FIG. 3. Referring to FIG. 4, the query includes syntaxes for obtaining the constraints of the referencing tables from an information_schema 10. If the query of FIG. 4 is input to the DBMS of the relational DB, a view table of constraints can be obtained as illustrated in FIG. 5. The constraints may be key constraints or table constraints.

According to another embodiment of the present invention, a query written differently from FIG. 4 can also be used as long as the constraints (key constraints or table constraints) of all referencing tables of the relational DB can be obtained.

An information_schema provides access to metadata of a DB, that is, DB, table name, and access privileges, etc. An information_schema introduced in MySQL 5.0 follows chapter 11 ‘schemata’ of the ANSI/ISO SQL 2003 standard definition and mostly satisfies ‘basic information schema’ which is core definition of the SQL 2003 standard. In MySQL 5.0, access to the information_schema is made through a typical SELECT statement. More detailed information about the information_schema can be found at “http://en.wikipedia.org/wiki/Information_schema.” The information_schema is a virtual DB, and tables of the information_schema are all view tables.

The constraints may be the key constraints or the table constraints. In the information_schema, the key constraints can be accessed by ‘information_schema.KEY_COLUMN_USAGE’, and the table constraints can be accessed by ‘information_schema.TABLE_CONSTRAINTS’.

The query of FIG. 4 accesses both the key constraints and the table constraints in the information_schema. In the query of FIG. 4, substantially the same key constraints and table constraints are searched for using CONSTRAINT_NAME as a key. In addition, information obtained from the key constraints and information obtained from the table constraints are collected, and the collected information is output as response data to the query.

If the query of FIG. 4 is input, data having columns of FIG. 5 is output. The output data has six columns: CONSTRAINT_NAME 20, TABLE_NAME 22, COLUMN_NAME 24, REFERENCED_TABLE_NAME 26, REFERENCED_COLUMN_NAME 28, and PK_YN 30. Each row of the table (not an actual table in the relational DB) illustrated in FIG. 5 denotes a constraint.

CONSTRAINT_NAME 20 is a column of constraint names (‘information_schema.TABLE_CONSTRAINTS.CONSTRAINT_NAME’ or ‘information_schema.KEY_COLUMN_USAGE.CONSTRAINT_NAME’) obtained from the key constraints or the table constraints of the information_schema.

TABLE_NAME 22 is a column of table names (‘information_schema.TABLE_CONSTRAINTS.TABLE_NAME’ or ‘information_schema.KEY_COLUMN_USAGE.TABLE_NAME’) obtained from the key constraints or the table constraints of the information_schema. TABLE_NAME 22 can be understood as a column of names of referencing tables having a foreign key.

COLUMN_NAME 24 is a column of column names (‘information_schema KEY_COLUMN_USAGE.COLUMN_NAME’) obtained from the key constraints of the information_schema. COLUMN_NAME 24 can be understood as a column of names of columns set as foreign keys among columns of referencing tables.

REFERENCED_TABLE_NAME 26 is a column of referenced table names (information_schema.KEY_COLUMN_USAGE.REFERENCED_TABLE_NAME’) obtained from the key constraints of the information_schema. REFERENCED_TABLE_NAME 26 can be understood as a column of names of tables referenced by columns (=foreign keys) specified in COLUMN_NAME 24.

REFERENCED_COLUMN_NAME 28 is a column of referenced column names (‘information_schema.KEY_COLUMN_USAGE.REFERENCED_COLUMN_NAME’) obtained from the key constraints of the information_schema. REFERENCED_COLUMN_NAME 28 can be understood as a column of names of columns of referenced tables which are referenced by the columns (=foreign keys) specified in COLUMN_NAME 24.

PK_YN 30 is a column indicating whether COLUMN_NAME 24 is a primary key, that is, whether COLUMN_NAME which is a foreign key is also set as a primary key.

In summary, constraint data output as a result of the input of the query may include a column of identification information of referencing tables, a column of identification information of columns set as foreign keys in the referencing tables, a column of identification information of tables referenced by the foreign keys, a column of identification information of columns of the referenced tables which are referenced by the foreign keys, and a column of flags, each indicating whether the column set as the foreign key is also set as a primary key.

In other words, the query may be written such that identification information of referencing tables, identification information of columns set as foreign keys in the referencing tables, the identification information of tables referenced by the foreign keys, identification information of columns of the referenced tables which are referenced by the foreign keys, and flags, each indicating whether the column offset as the foreign key is also set as a primary key, are included as columns and that each constraint is row data.

In the constraint data of FIG. 5, a first row, i.e., a first constraint indicates that ‘COLUMN_A1, a foreign key of TABLE_A, references COLUMN_B1 of TABLE_B and that COLUMN_B1 is a primary key of TABLE_B.’

Referring back to FIG. 3, if constraint data is output as a result of the input of the query (operation S100), the output constraint data is analyzed to determine a relation type of each referencing table (operation S200). The relation type may be one of the relation types illustrated in FIG. 2. However, since the 1:1 relation and the 1:N relation are regarded as the same relation, the relation type may be one of the 1:N relation, the M:N relation, the parallel relation, and the reflexive relation.

Referencing tables whose relation types are to be determined are determined by referencing table names specified in the TABLE_NAME column 22 of the constraint data. For example, in the case of the constraint data of FIG. 5 (omitted information will not be considered), referencing table names (TABLE_NAME) for three constraints (TABLE_A_ibfk_{—}1, TABLE_A_ibfk_{—}2, TABLE_D_ibfk_{—}1) are TABLE_A and TABLE_D. Therefore, the relation type will be determined for each of TABLE_A and TABLE_D.

According to an embodiment, a relation type of a referencing table may be determined using the number of constraints of the referencing table. ‘Using the number of constraints’ denotes that the number of constraints is taken into consideration as one factor in the process of determining the relation type of the referencing table but does not denote that the relation type of the referencing table is determined solely by the number of constraints.

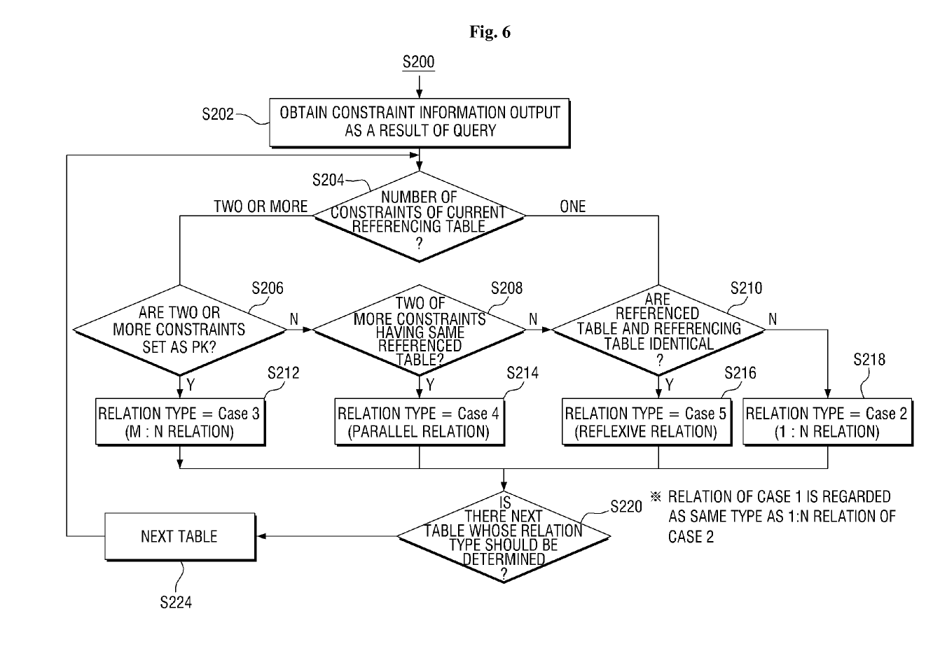

How the relation type of each referencing table is determined using constraint data output as a result of a query will now be described with reference to FIG. 6.

Once constraint data output as a result of a query is obtained (operation S202) as described above, the number of constraints included in a current referencing table is identified (operation S204). The subsequent determination process may depend on whether the current referencing table has two or more constraints or only one constraint.

If the current referencing table has two or more constraints, it is determined whether a referencing column of each constraint is set as a primary key (operation S206). If the current referencing table has two or more constraints set as a primary key, the relation type of the current referencing table is determined to be the M:N relation (operation S212). Whether the referencing column of each constraint set as a primary key is specified in the PK_YN column 30.

If the current referencing table has two or more constraints but does not have two or more constraints set as primary keys, it is determined whether the current referencing table includes two or more constraints having the same referenced table (operation S208). If the current reference table includes two or more constraints having the same referenced table, the relation type of the current referencing table is determined to be the parallel relation (operation S214).

If the current referencing table has two or more constraints but does not have two or more referenced columns set as primary keys and two or more constraints having the same referenced table, it is determined whether there is a constraint having a referenced table identical to the current referencing table (operation S210). If there is a constraint having the referenced table identical to the current referencing table, the relation type of the current referencing table is determined to be the reflexive relation (operation S216). If there is no constraint having the referenced table identical to the current referencing table, the relation type of the current referencing table is determined to be the 1:N relation (operation S218).

If the current refereeing table has only one constraint (operation S204), it is determined whether the constraint includes the same table as both a referencing table and a referenced table (operation S210). If a referenced table of the sole constraint of the current referencing table is the same as the current referencing table, the relation type of the current referencing table is determined to be the reflexive relation (operation S216). If the referenced table of the sole constraint of the current referencing table is different from the current referencing table, the relation type of the current referencing table is determined to be the 1:N relation (operation S218).

After the relation type of the current referencing table is determined, it is determined whether referencing tables whose relation types should be determined are still left in the constraint data output as a result of the input of the query (operation S220). If there remain the referencing tables whose relation types should be determined, the relation type of a next table is determined (operation S224).

Referring back to FIG. 3, after the relation type of each referencing table is determined, a node generation target table and a relation frame are generated for each referencing table.

The node generation target table is a table converted into nodes of a graph DB. That is, each row of the node generation target table is converted into a node. For example, if the node generation target table has ten rows, ten nodes are generated from the node generation target table. The term ‘row’ is widely used in the DB field and has the same meaning as record and tuple.

The relation frame is a rule for generating a relation of the graph DB. The relation frame specifies which types of nodes should be connected by a relation. For example, the relation frame may specify that a relation connecting a node generated from TABLE_A and a node generated from TABLE_B should be generated. In addition, the relation frame may specify which nodes should be connected. For example, the relation frame may specify that node X whose COLUMN_A0 has a value of 10 among nodes generated from TABLE_A and node Y whose COLUMN_B3 has a value of 10 among nodes generated from TABLE_B should be connected.

For example, if the relation frame is shown as ‘TB_EMAIL(SENDER_ID)→‘TB_USER(USER_ID)’, a node generated from a TB_EMAIL table is connected to a node generated from a TB_USER table in this direction by a relation. In this case, SENDER_ID and USER_ID columns of the two nodes have the same value.

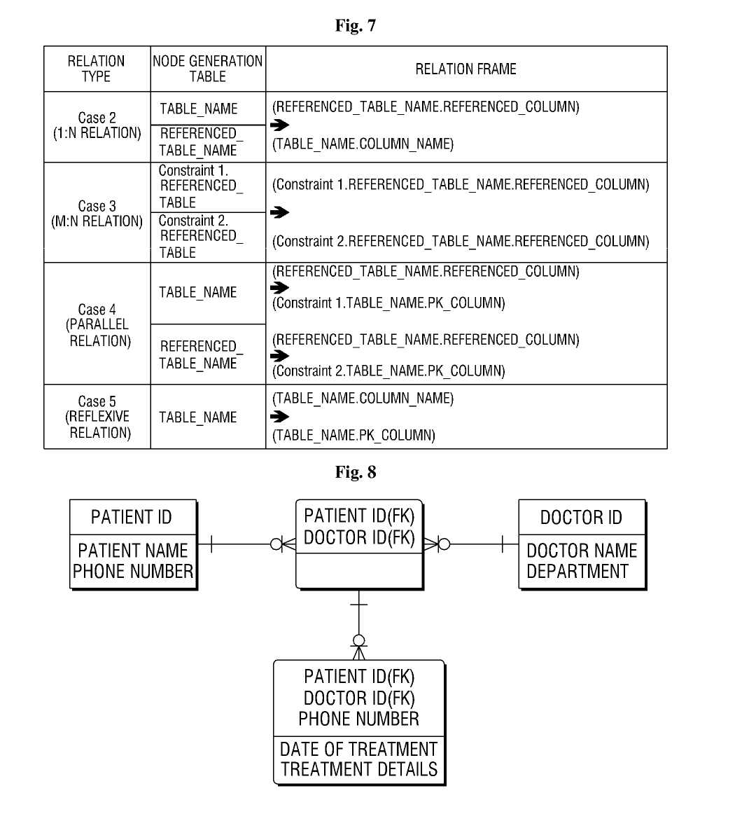

A rule corresponding to the relation type of each referencing table is used in the process of generating the node generation target table and the relation frame for each referencing table. The node generation target table and the relation frame for each referencing table are determined using data of each column included in the constraint data according to the rule corresponding to the relation type of each referencing table. This will now be described in detail with reference to FIG. 7.

As already mentioned above, the 1:1 relation and the 1:N relation are regarded as the same relation. Therefore, how the node generation target table and the relation frame are generated for four of the five relation types of FIG. 2 will now be described with reference to FIG. 7. FIG. 7 is a table showing how a node and a relation are generated for each relation type.

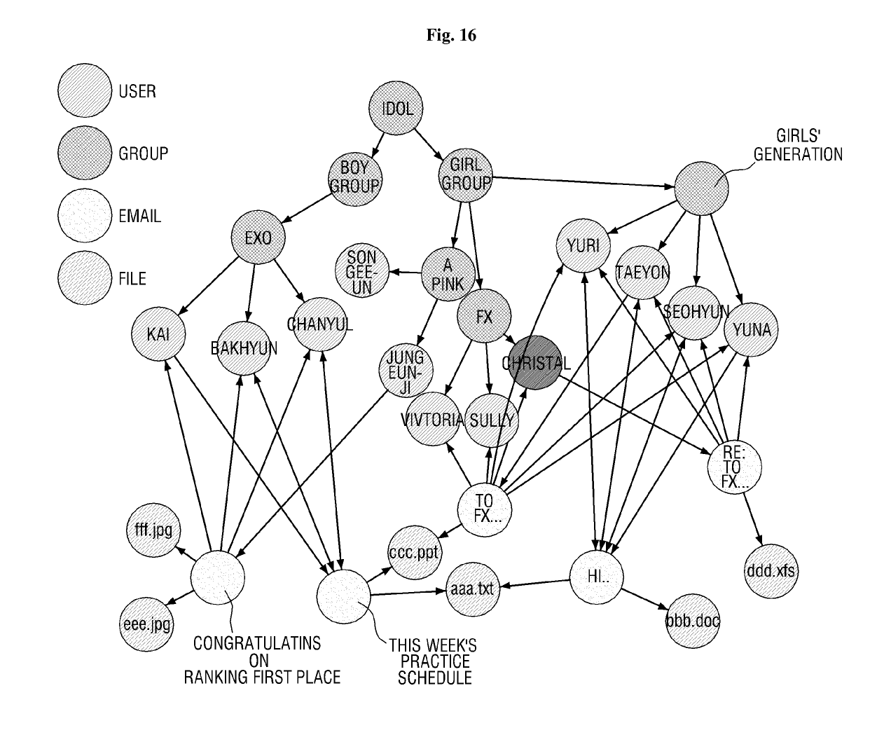

If the relation type of a referencing table is the 1:N relation, the node generation target table is determined to be the referencing table and a referenced table of the referencing table. In addition, the relation frame is determined to be a relation frame that connects a node of the referencing table and a node of the referenced table, specifically, a relation frame that connects nodes in which data of a column (a foreign key) of the referencing table matches data of a referenced column of the referenced table. In FIG. 7, a relation is directed from a referencing table to a referenced table. However, this is merely an example, and the relation may not have directionality. Even if the relation has directionality, the directionality of the relation can be changed by a user's setting. Setting the directionality of the relation will be described in greater detail later with reference to FIGS. 17 through 19.

If the relation type of the referencing table is the M:N relation, the node generation target table is determined to be a referenced table of a first constraint of the referencing table and a referenced table of a second constraint of the referencing table. In addition, the relation frame is determined to be a relation frame that connects a node of the referenced table of the first constraint of the referencing table and a node of the referenced table of the second constraint of the referencing table, specifically, a relation frame that connects nodes in which data of a referenced column of the referenced table of the first constraint of the referencing table matches data of a referenced column of the referenced table of the second constraint of the referencing table.

If a referencing table has the M:N relation, it indicates that a first referenced table of the referencing table and a second referenced table of the referencing table are connected through the referencing table, and the referencing table references both a primary key of the first referenced table and a primary key of the second referenced table.

In FIG. 7, a case where only two constraints exist in a referencing table is illustrated. However, since the M:N relation can exist when there are two or more constraints (see FIG. 4), it is also applicable when there are three or more constraints. For example, if there are three constraints, the node generation target table is determined to be a referenced table of a first constraint of the referencing table, a referenced table of a second constraint of the referencing table, and a referenced table of a third constraint of the referencing table. In addition, the relation frame is determined to be a relation frame specifying that a first relation connecting a node of the referenced table of the first constraint and a node of the referenced table of the second constraint, a second relation connecting a node of the referenced table of the second constraint and a node of the referenced table of the third constraint, and a third relation connecting a node of the referenced table of the third constraint and a node of the referenced table of the first constraint should be generated. Here, the first relation connects nodes in which data of a referenced column of the referenced table of the first constraint of the referencing table matches data of a referenced column of the referenced table of the second constraint of the referencing table. The second relation connects nodes in which data of a referenced column of the referenced table of the second constraint of the referencing table matches data of a referenced column of the referenced table of the third constraint of the referencing table. The third relation connects nodes in which data of a referenced column of the referenced table of the third constraint of the referencing table matches data of a referenced column of the referenced table of the first constraint of the referencing table.

In general, a referencing table having a constraints and the M:N relation includes each of a referenced table of a first constraint, a referenced table of a second constraint, . . . , a referenced table of an a^{th} constraint as a node generation target table and has a relation frame including ₐC₂ relations, where ₐC₂ is a number of case that selects two from a regardless of order.

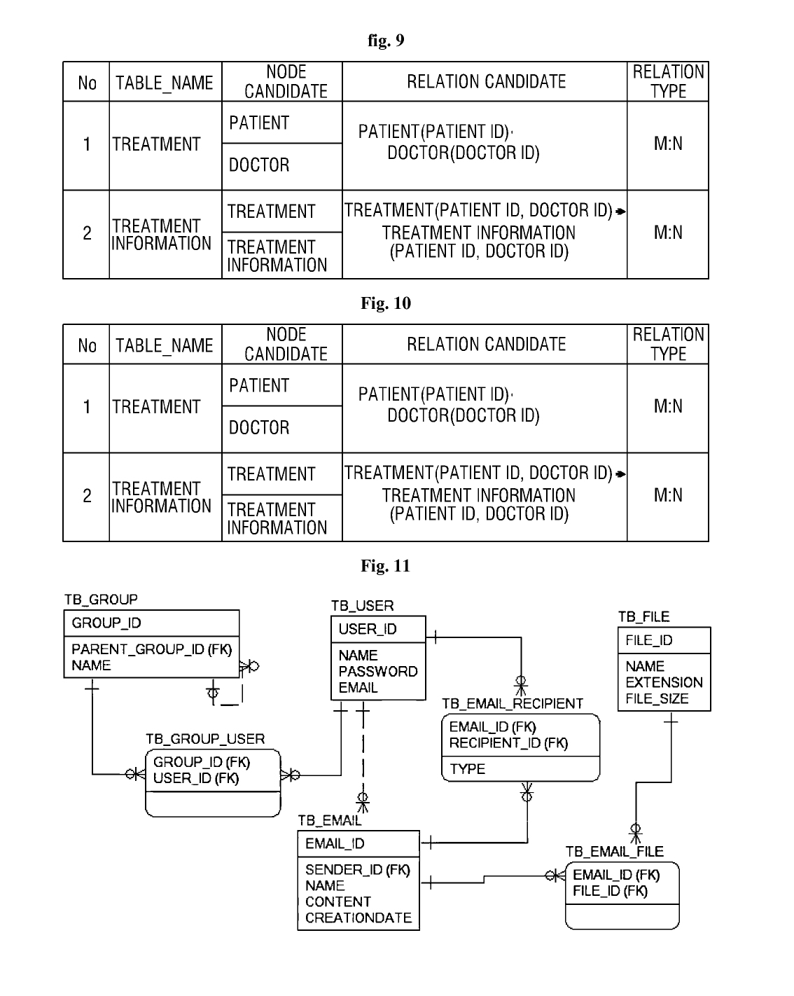

For the M:N relation, a node generation target table and a relation frame are generated as described above. However, if a referencing table having the M:N relation is referenced by another referencing table and if the another referencing table can have the 1:N relation, the node generation target table and the relation frame may be generated as an exception. This case will now be described with reference to FIGS. 8 through 10.

Operations S100 and S200 of FIG. 3 are performed for the connection relationship between tables of a relational DB illustrated in FIG. 8, and a node generation target table and a relation frame are generated for each referencing table (a treatment table, a treatment information table) in the same way as described above FIG. 7. The results are illustrated in FIG. 9. Referring to FIG. 9, a treatment table which is a referencing table having the M:N relation is not included in the node generation target table through a constraint of the treatment table. However, since the treatment information table references the treatment table in the 1:N relation, the treatment table can be included in the node generation target table and the relation frame for the treatment table may be determined as illustrated in FIG. 10.

That is, if a referencing table having the M:N relation is referenced by another referencing table and if the another referencing table has the 1:N relation, the node generation target table of the referencing table is determined to be a referenced table of a first constraint of the referencing table and a referenced table of a second constraint of the referencing table. In addition, the relation frame of the referencing table includes a first relation frame and a second relation frame. The first relation frame is determined to be a relation frame that connects a node of the referenced table of the first constraint of the referencing table and a node of the referencing table, and the second relation frame is determined to be a relation frame that connects a node of the referenced table of the second constraint of the referencing table and a node of the referencing table. Specifically, the first relation frame is determined to a relation frame that connects nodes in which data of a referenced column of the referenced table of the first constraint of the referencing table matches data of a referenced column of the first constraint of the referencing table. The second relation frame is determined to be a relation frame that connects nodes in which data of a referenced column of the referenced table of the second constraint of the referencing table matches data of a referenced column of the second constraint of the referencing table.

Referring back to FIG. 7, the node generation target table and the relation frame are generated as follows in cases where the relation type of a referencing table is the parallel relation and the reflexive relation.

If the relation type of a referencing table is the parallel relation, the node generation target table is determined to be the referencing table and a referenced table of the referencing table, and the relation frame includes a first relation frame and a second relation frame. The first relation frame is determined to be a relation frame that connects a node of a referenced table of the referencing table and a node of a referencing table of a first constraint of the referencing table, and the second relation frame is determined to be a relation frame that connects a node of a referenced table of the referencing table and a node of a referencing table of a second constraint of the referencing table. Specifically, the first relation frame is determined to a relation frame that connects nodes in which data of a referenced column of the referenced table of the referencing table matches data of a primary key column of the referencing table of the first constraint of the referencing table. The second relation frame is determined to be a relation frame that connects nodes in which data of a referenced column of the referenced table of the referencing table matches data of a primary key column of the referencing table of the second constraint of the referencing table.

If the relation type of the referencing table is the reflexive relation, the node generation target table is determined to be the referencing table, and the relation frame is determined to be a relation frame that connects a first node and a second node of the referencing table, specifically, a relation frame that connects nodes in which data of a referencing column (a foreign key) of the first node matches data of a primary key column of the second node.

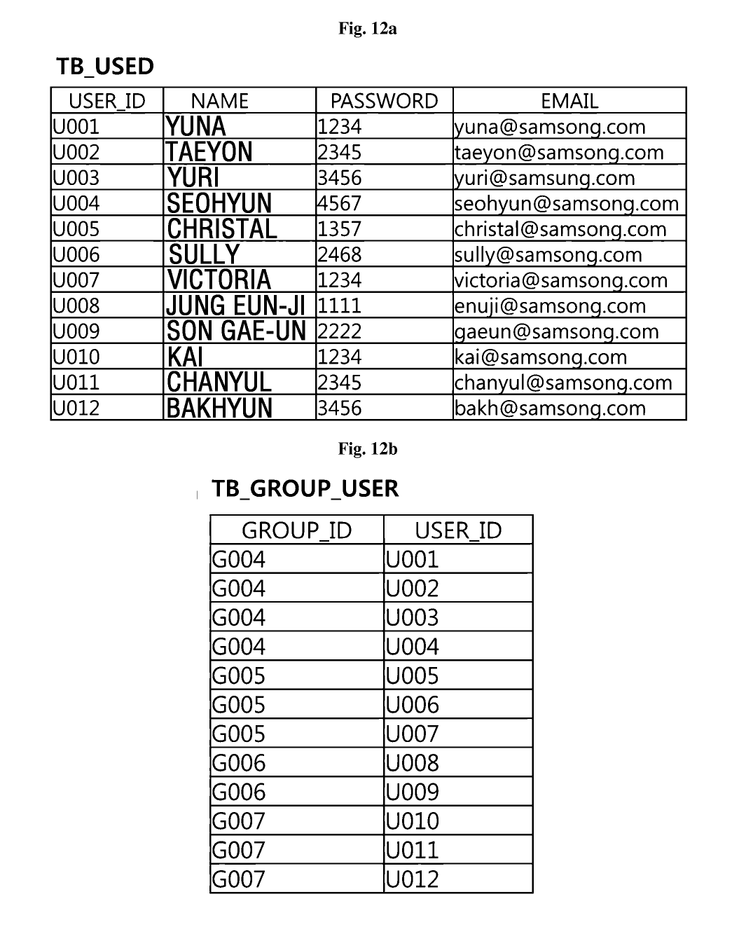

An application example of the DB migration method according to the above-described embodiment will now be described with reference to FIGS. 11 through 16.

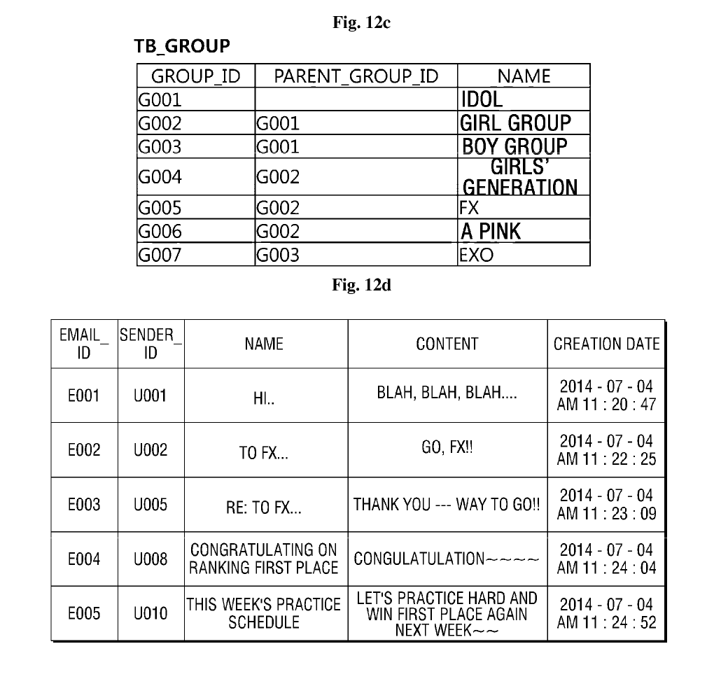

FIG. 11 is a diagram illustrating the relationships between tables of a relational DB that are to be migrated to a graph DB. FIGS. 12A through 12G illustrate row data input to the tables shown in the diagram of FIG. 11. The DB migration method according to the current embodiment converts the relational DB of FIGS. 11 through 12G into a graph DB.

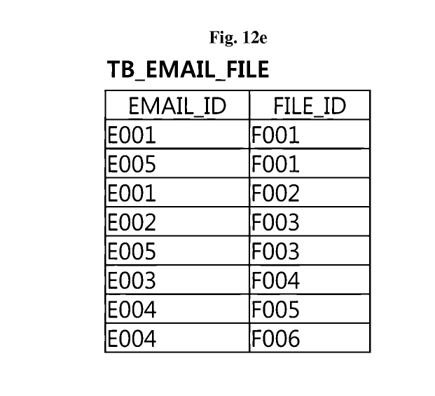

A query for collecting constraints of all referencing tables having a column set as a foreign key among tables included in the relational DB of FIGS. 11 through 12G may be input to a DBMS that manages the relational DB. As a result of the input of the query, constraint data may be output as illustrated in FIG. 13. Referring to FIG. 13, the constraint data includes five referencing tables (TB_EMAIL, TB_EMAIL_FILE, TB_EMAIL_RECIPIENT, TB_GROUP, and TB_GROUP_USER) and eight constraints.

The relation type of each referencing table will be determined as follows. The following description is about a process of applying the logic suggested in FIG. 6 to actual examples.

TB_EMAIL has one constraint (TB_EMAIL_ibfk_{—}1). In addition, TB_EMAIL references another table (TB_USER in REFERENCED_TABLE_NAME). Therefore, TB_EMAIL has the 1:N relation with TB_USER.

TB_EMAIL_FILE has two constraints (TB_EMAIL_FILE_ibfk_{—}1 and TB_EMAIL_FILE_ibfk_{—}2). In addition, the two constraints are set as primary keys (Y in the PK column). Therefore, TB_EMAIL_FILE has the M:N relation with TB_EMAIL and TB_FILE.

TB_EMAIL_RECIPIENT also has two constraints (TB_EMAIL_RECIPIENT_ibfk_{—}1 and TB_EMAIL_RECIPIENT_ibfk_{—}2). In addition, the two constraints are set as primary keys (Y in the PK column). Therefore, TB_EMAIL_FILE has the M:N relation with TB_EMAIL and TB_FILE.

TB_GROUP has one constraint (TB_GROUP_ibfk_{—}1). In addition, TB_GROUP references itself (REFERENCED_TABLE_NAME). Therefore, TB_GROUP has the reflexive relation with itself.

TB_GROUP_USER has two constraints (TB_GROUP_USER_ibfk_{—}1 and TB_GROUP_USER_ibfk_{—}2). In addition, the two constraints are set as primary keys (Y in the PK column). Therefore, TB_GROUP_USER has the M:N relation with TB_GROUP and TB_USER.

Next, rules for generating a node generation target table and a relation frame according to the relation type of each referencing table will be applied as follows. The following description is about a process of applying the rules suggested in FIG. 7 to actual examples.

In the case of TB_EMAIL having the 1:N relation, a node generation target table is determined to be TB_USER (i.e., a referenced table) and TB_EMAIL (i.e., a referencing table). In addition, a relation frame is defined as connecting a node of TB_EMAIL and a node of TB_USER, specifically, connecting nodes, in which SENDER_ID data(column SENDER_ID is set as a foreign key in TB_EMAIL) of TB_EMAIL, matches USER_ID data(column USER_ID is referenced by SENDER_ID) of TB_USER.

In the case of TB_EMAIL_FILE having the M:N relation type, the node generation target table is determined to be TB_EMAIL (i.e., a referenced table) of TB_EMAIL_FILE_ibfk_{—}1 (i.e., a first constraint) and TB_FILE (i.e., a referenced table) of TB_EMAIL_FILE_ibfk_{—}2 (i.e., a second constraint). In addition, the relation frame is determined to be a relation frame that connects the referenced table (TB_EMAIL) of the first constraint and the referenced table (TB_FILE) of the second constraint. Specifically, the relation frame is determined to be a relation frame that connects nodes in which data of a referenced column (EMAIL_ID) of the referenced table of the first constraint matches data of a referenced column (FILE_ID) of the referenced table of the second constraint. The node generation target table and the relation frame are also determined in the same way as described above for two other tables (TB_EMAIL_RECIPIENT and TB_GROUP_USER) having the M:N relation type.

In the case of TB_GROUP having the reflexive relation type, the node generation target table is determined to be itself (i.e., TB_GROUP). In addition, the relation frame is determined to be a relation frame that connects nodes of TB_GROUP, specifically, a relation frame that connects nodes in which data of PARENT_GROUP_ID (i.e., a referencing table) of TB_GROUP matches data of GROUP_ID (i.e., a column set as a primary key) of TB_GROUP.

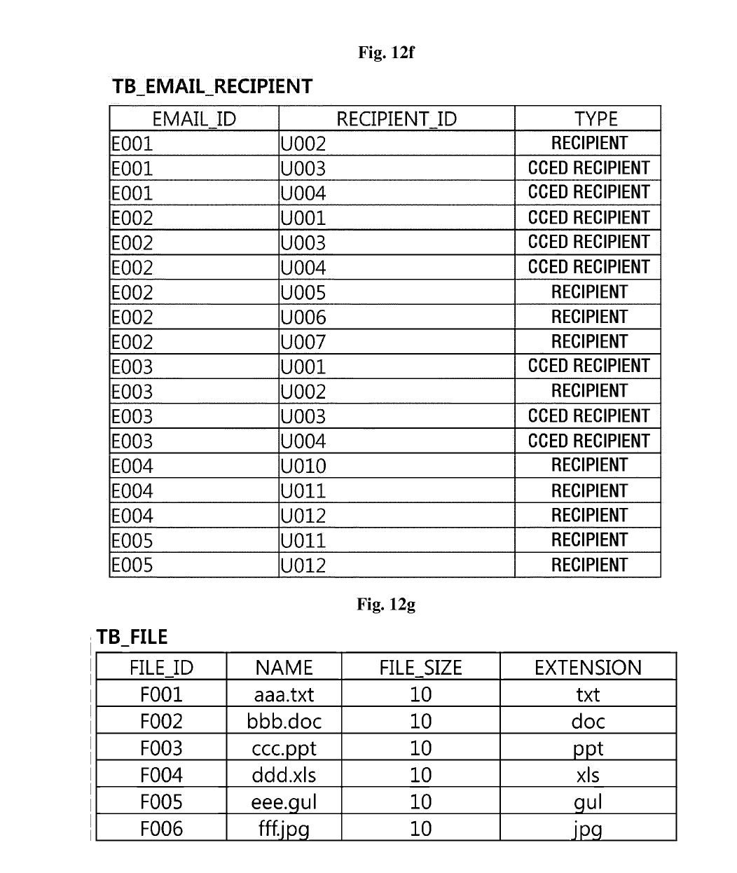

FIG. 14 illustrates the relation type, node generation target table, and relation frame of each referencing table.

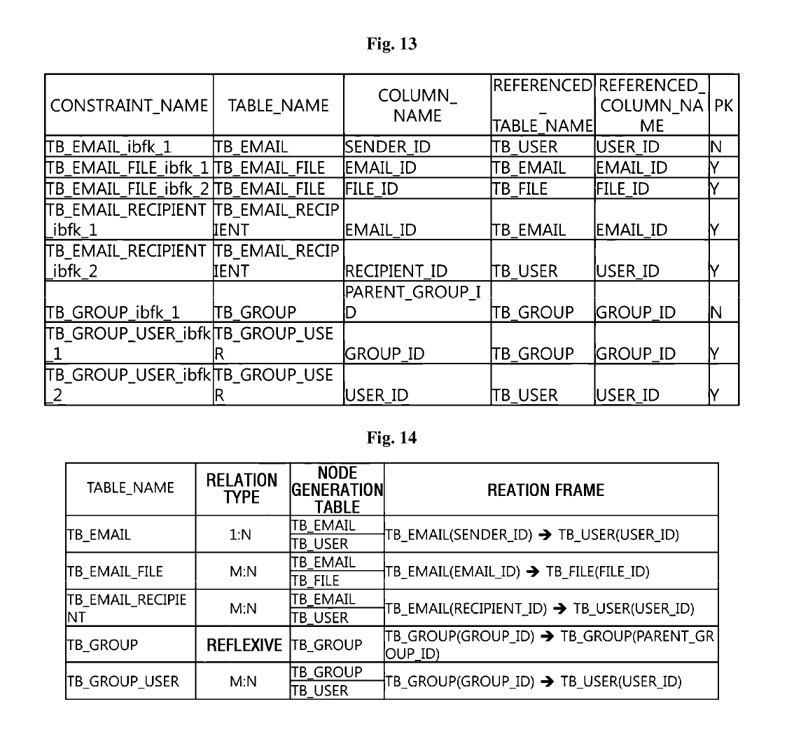

Next, a node list is generated by collecting node generation target tables, and a relation list is generated by collecting relation frames. The node list is a list of tables containing data that should be converted into nodes of a graph DB. The relation list is a list of rules (nodes generated from which tables should be connected and which nodes should be connected based on a column value of each node) for generating relations that should be converted into relations of the graph DB. FIG. 15 illustrates a node list and a relation list reflecting FIG. 14.

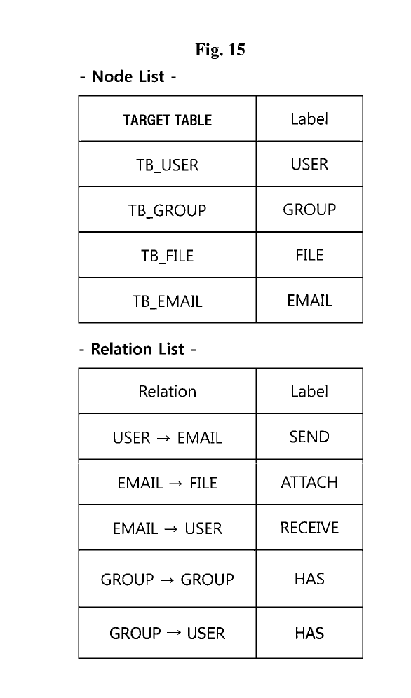

FIG. 16 illustrates a graph DB to which data of the relational DB of FIGS. 11 through 12G has been migrated.

The reason why some of the nodes and relations illustrated in FIG. 16 have been generated will now be described. Of node generation target tables included in the node list, TB_USER has twelve rows as illustrated in FIG. 12A. Therefore, twelve nodes are generated from TB_USER as illustrated in FIG. 16. In addition, there are three relations that connect nodes generated from TB_USER with other nodes as illustrated in FIG. 15. That is, a node generated from TB_USER and a node generated from TB_EMAIL are connected (relation label: SEND), a node generated from TB_EMAIL and a node generated from TB_USER are connected (relation label: RECEIVE), and a node generated from TB_GROUP and a node generated from TB_USER are connected.

For example, a ‘Jung Eun-ji’ node generated from the TB_USER table is connected to an ‘A Pink’ node generated from TB_GROUP and a ‘Congratulations on ranking first place’ node generated from the TB_EMAIL table. It can be easily identified from these connections that user ‘Jung Eun-ji’ belongs to group ‘A Pink’ and has received an e-mail saying ‘Congratulations on ranking first place.’ If the data were managed using a conventional relational DB, a SELECT query would have to be executed to find the group to which user ‘Jung Eun-ji’ belongs, and another SELECT query would have to be executed to find the e-mail that user ‘Jung Eun-ji’ has received. Therefore, the graph DB requires a reduced amount of computation to identify the associative relationship between data, as compared with the conventional relational DB.

A DB migration method according to another embodiment of the present invention will now be described with reference to FIG. 17. Operations S100 through S500 of FIG. 17 are the same as those of FIG. 3. The current embodiment provides a user interface (UI) used to set properties and a label of a node and properties and a label of a relation.

Referring to FIG. 17, a UI may be provided to select properties, which are to be included in a node generated from each node generation target table on the node list, from columns of each node generation target table and to input a label of the node generated from each node generation target table on the node list (operation S600).

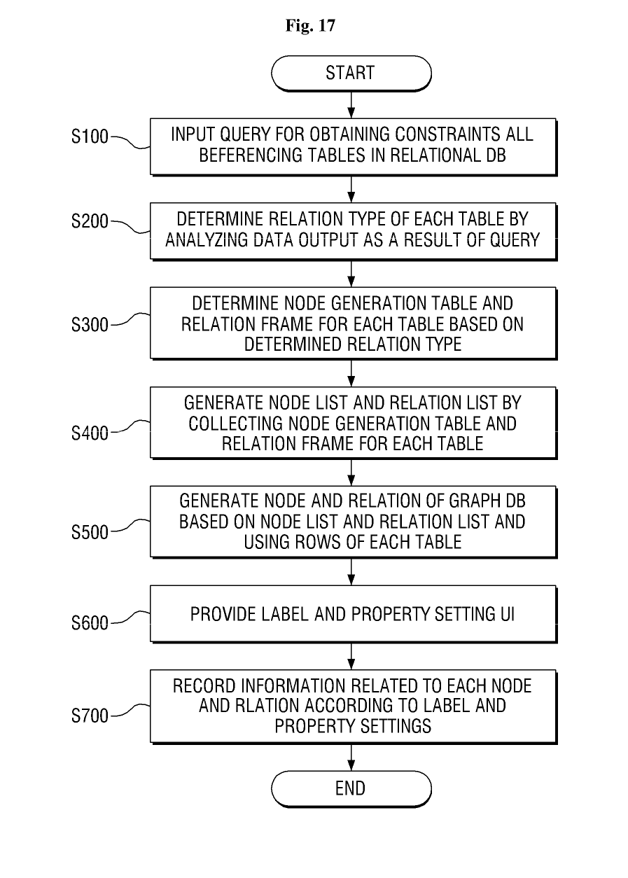

FIG. 18 is an example of a node property and label setting UI that can be provided to a user. Referring to FIG. 18, a user may determine which columns of a specific table will be used as properties of a node generated from the specific table. In addition, the user may input a label name of the node generated from the specific table.

Further, another UI may be provided to input properties and a label, which are to be included in a relation generated by each relation frame on the relation list, and to designate a direction of the relation (operation S600). According to an embodiment, only one of the two UIs may be provided.

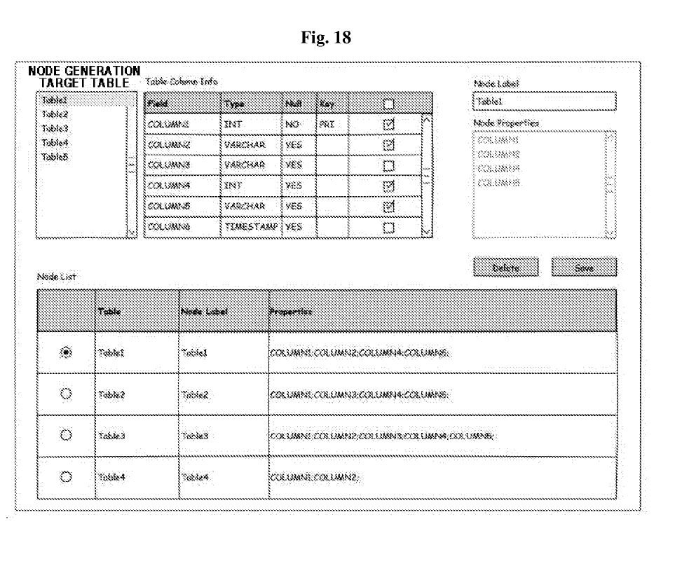

FIG. 19 is an example of a relation property and label setting UI that can be provided to a user. Referring to FIG. 19, a user may input a direction of a relation and a label of the relation for a specific relation frame. In addition, the user may select a source table which will provide properties of the relation and select at least some of columns of the source table as properties of the relation.

According to an embodiment, the source table may be set by default as a referencing table when the relation frame is generated.

In FIG. 17, the providing of the UIs (operation S600) is performed after operation S500. However, according to an embodiment, operation S500 can be performed after properties and labels of a node and a relation are determined by providing the UIs (operation S600).

Next, property information and label information according to property and label settings are additionally recorded in node data and relation data of the graph DB (operation S700).

The DB migration methods according to the embodiments described above with reference to FIGS. 1 through 19 can also be embodied as computer-readable code on a computer-readable recording medium. The computer-readable recording medium may be a portable recording medium (such as a compact disc (CD), a digital video disc (DVD), a Blu-ray disc, a universal serial bus (USB) storage device, or a portable hard disk) or a fixed recording medium (such as a read only memory (ROM), a random access memory (RAM), or a hard disk built in a computer). The computer program recorded on the computer-readable recording medium can be transmitted to another computing device through the network such as the Internet and installed on the computer device. Accordingly, the computer program can be used by the computing device.

According to another embodiment of the present invention, a computer program for executing each operation of the DB migration methods according to the embodiments described above with reference to FIGS. 1 through 19 may be provided. The computer program can be coupled to and executed on a device (such as a computer, a smartphone, etc.) equipped with operation means and can be recorded on a computer-readable medium.

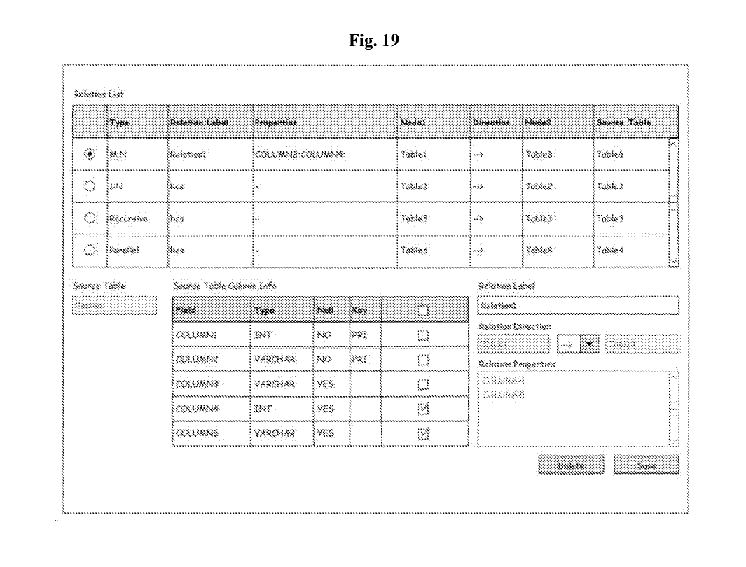

FIG. 20 illustrates the configuration of a DB migration system according to an embodiment of the present invention. The DB migration system according to the current embodiment includes a relational DB server 200, a graph DB server 300, and a DB converter 100. The DB converter 100 receives data of a source DB from the relational DB server 200, generates node and relation data for a graph DB using the received data, and provides the generated node and relation data to the graph DB server 300.

According to an embodiment, the graph DB server 300 may be implemented in or connected to a server that provides a social network service.

The DB converter 100 collects constraints of referencing tables having a column set as a foreign key among referencing tables of a relational DB which is a migration source DB. Then, the DB converter 100 determines a relation type of each referencing table based on constraints of the referencing table and determines a node generation target table and a relation frame for each referencing table based on the relation type of the referencing table. In addition, the DB converter 100 generates a node list and a relation list by collecting the node generation target table and the relation frame corresponding to each referencing table. The DB converter 100 converts data in each row of each of all node generation target tables on the node list into a node of the graph DB. In addition, the DB converter 100 generates a relation of the graph DB according to each of all relation frames on the relation list.

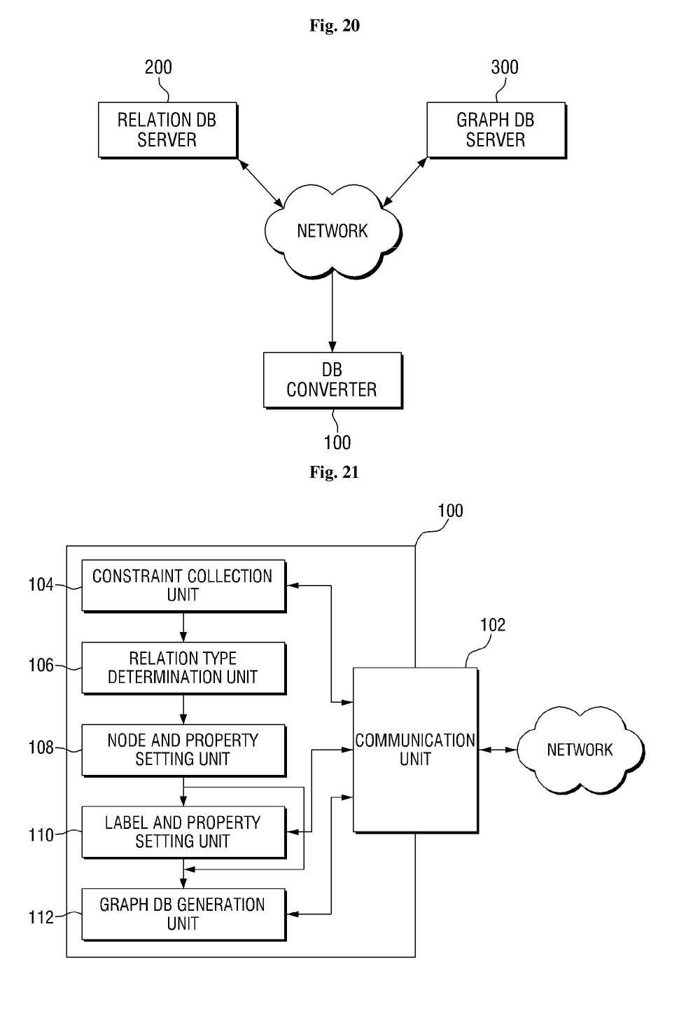

The configuration and operation of a DB migration device 100 according to another embodiment of the present invention will now be described with reference to FIG. 21. Referring to FIG. 21, the DB migration device 100 according to the current embodiment may include a constraint collection unit 104, a relation type determination unit 106, a node and relation determination unit 108, and a graph DB generation unit 112, and a communication unit 102. The communication unit 102 relays the connection between the DB migration device 100 and a network.

The constraint collection unit 104 collects constraints of referencing tables having a column set as a foreign key among tables of a relational DB which is a migration source DB.

The relation type determination unit 106 determines the relation type of each referencing table based on constraints of the referencing table.

The node and relation determination unit 108 determines a node generation target table and a relation frame for each referencing table based on the relation type of the referencing table.

The graph DB generation unit 112 converts data in each row of the node generation target table into a node of a graph DB which is a migration target DB and generates a relation of the graph DB, which connects the generated nodes, according to the relation frame.

In an embodiment, the graph DB generation unit 112 may generate a node list and a relation list by collecting the node generation target table and the relation frame corresponding to each referencing table, convert data in each row of each of all node generation target tables on the node list into a node of the graph DB, and generate a relation of the graph DB according to each of all relation frames on the relation list.

In an embodiment, the constraint collection unit, the relation type determination unit, the node and relation determination unit, and the graph DB generation unit are implemented via at least one CPU or at least one hardware processor.

In an embodiment, the DB migration apparatus 100 may further include a label and property setting unit 110. The label and property setting unit 110 may provide the UI of FIG. 18 or 19 to user equipment (not illustrated) through the communication unit 102. That is, the label and property setting unit 110 may provide a UI used to select properties, which are to be included in a node generated from each node generation target table on the node list, from columns of each node generation target table and to input a label of the node generated from each node generation target table on the node list. In addition, the label and property setting unit 110 may provide a UI used to input properties and a label, which are to be included in a relation generated by each relation frame on the relation list, and to designate a direction of the relation.

In an embodiment, the DB migration apparatus 100 may deactivate the label and property setting unit 110 or may not include the label and property setting unit 110. In this case, the node and relation determination unit 108 sets properties and labels of each node and relation to default values based on a preset standard.

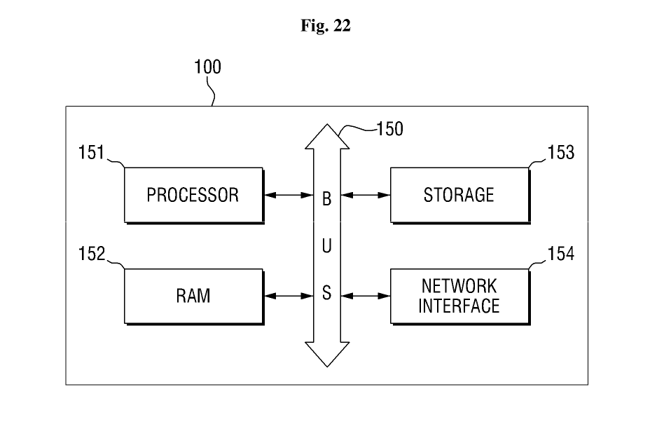

The configuration and operation of a DB migration apparatus 100 according to another embodiment of the present invention will now be described with reference to FIG. 22. The DB migration apparatus 100 according to the current embodiment may include a system bus 150, a processor 151, a memory 152 (e.g., a RAM), a storage 153, and a network interface 154 for communication with an external device. Computer program code embodying the DB migration methods according to the embodiments of FIGS. 1 through 19 can be stored in the storage 153, loaded on the memory 152, and executed by the processor 151.

According to embodiments of the present invention suggested in the present specification, data recorded in a relational DB can be automatically migrated to a graph DB. Automatically migrating the data recorded in the relational DB to the graph DB denotes that a logic performing a series of operations identifies the connection relationship between tables of the relational DB which is a source DB, automatically selects a node generation target table which should be converted into a node of the graph DB according to the connection relationship, and automatically generates a relation between nodes of the graph DB in view of the connection relationship.

Therefore, no or reduced manpower required to migrate data from the relational DB to the graph DB.

The foregoing is illustrative of the present invention and is not to be construed as limiting thereof. Although a few embodiments of the present invention have been described, those skilled in the art will readily appreciate that many modifications are possible in the embodiments without materially departing from the novel teachings and advantages of the present invention. Accordingly, all such modifications are intended to be included within the scope of the present invention as defined in the claims. Therefore, it is to be understood that the foregoing is illustrative of the present invention and is not to be construed as limited to the specific embodiments disclosed, and that modifications to the disclosed embodiments, as well as other embodiments, are intended to be included within the scope of the appended claims. The present invention is defined by the following claims, with equivalents of the claims to be included therein.

What is claimed is:

1. A database (DB) migration method comprising:
collecting a plurality of constraints of a referencing table having a column set as a foreign key, the referencing table being one of a plurality of referencing tables, and the plurality of referencing tables being among tables of a relational DB which is a migration source DB;
determining a relation type of the referencing table, based on the plurality of constraints of the referencing table;
determining a node generation target table and a relation frame for the referencing table, based on the relation type of the referencing table; and
converting a plurality of pieces of data in a row of the node generation target table into a node of a graph DB which is a migration target DB, and generating a relation of the graph DB, which connects the generated node to a plurality of other nodes, according to the relation frame.

2. The method of claim 1, wherein the determining of the relation type of the referencing table comprises using the number of constraints in the plurality of constraints of the referencing table.

3. The method of claim 1, wherein the converting further comprises:
generating a node list and a relation list by collecting a plurality of node generation target tables and a plurality of relation frames, one of each of the plurality of node generation target tables and the plurality of relation frames corresponding to one of each of the plurality of referencing tables;
for each of the plurality of node generation target tables on the node list, converting a plurality of pieces of data in each row of a plurality of rows into a corresponding node of the graph DB, the corresponding node being one of the plurality of other nodes; and
for each of the plurality of relation frames on the relation list, generating a corresponding relation of the graph DB, the corresponding relation being one of a plurality of corresponding relations.

4. The method of claim 3, further comprising providing a user interface (UI) configured to be used to:
select properties which are to be included in the corresponding node from columns of a respective node generation target table of the plurality of node generation target tables on the node list, the respective node generation target table corresponding to the corresponding node; and
to input a label of the corresponding node, the label being generated from the respective node generation target table.

5. The method of claim 3, further comprising providing a UI configured to be used to input properties and a label, which are to be included in the corresponding relation generated by a respective relation frame on the relation list, and to designate a direction of the relation.

6. The method of claim 1, wherein the collecting comprises:
Inputting, to a database management system (DBMS) of the relational DB, a query for obtaining a view table, the view table containing information about a cumulative plurality of constraints of all of the plurality of referencing tables of the relational DB, from an information_schema; and
obtaining the view table in response to the query.

7. The method of claim 6, wherein the cumulative plurality of constraints are key constraints.

8. The method of claim 6, wherein the cumulative plurality of constraints are table constraints.

9. The method of claim 6, wherein the view table comprises a column of identification information of the plurality of referencing tables, a column of identification information of columns set as foreign keys in the plurality of referencing tables, a column of identification information of a plurality of tables referenced by the foreign keys, a column of identification information of a plurality of columns in the plurality of tables referenced , and a column of flags, each indicating whether column set as a foreign key is also set as a primary key in the referencing tables.

10. The method of claim 6, wherein the determining of the node generation target table and the relation frame further comprises using a second plurality of pieces of data of each column of a plurality of columns included in a first plurality pieces of data about the plurality of constraints according to a rule corresponding to the relation type of the referencing table.

11. The method of claim 1, wherein if the referencing table comprises two or more constraints and if the referencing table comprises two or more constraints set as a primary key, the determining of the relation type comprises determining the relation type of the referencing table to be a M:N relation.

12. The method of claim 1, wherein if the referencing table comprises two or more constraints and if the referencing table comprises less than two constraints set as a primary key, the determining of the relation type comprises determining that the referencing table comprises two or more constraints having a same referenced table.

13. The method of claim 12, wherein the determining that the referencing table comprises two or more constraints having the same referenced table comprises determining the relation type of the referencing table to be a parallel relation if it is determined that the referencing table comprises two or more constraints having the same referenced table.

14. The method of claim 12, wherein the determining that the referencing table comprises two or more constraints having the same referenced table comprises:
determining whether a referenced table of each constraint of the referencing table is the same as the referencing table if it is determined that each of the plurality of constraints of the referencing table has a unique referenced table of a plurality of referenced tables; and
determining the relation type of the referencing table to be a reflexive relation if the referenced table of each constraint of the plurality of constraints of the referencing table is the same as the referencing table and determining the relation type of the referencing table to be a 1:N relation if the referenced table of each constraint of the plurality of constraints of the referencing table is different from the referencing table.

15. The method of claim 1, wherein if the plurality of constraints of the referencing table has only one constraint, the determining of the relation type comprises determining the relation type of the referencing table to be one of a 1:N relation and a reflexive relation.

16. The method of claim 15, wherein the determining of the relation type of the referencing table to be one of the 1:N relation and the reflexive relation comprises:
determining the relation type of the referencing table to be the reflexive relation if a referenced table of each constraint of the plurality of constraints of the referencing table is the same as the referencing table, and determining the relation type of the referencing table to be the 1:N relation if the referenced table of each constraint of the plurality of constraints of the referencing table is different from the referencing table.

17. The method of claim 1, wherein the determining of the node generation target table and the relation frame for the referencing table comprises, if the relation type of the referencing table is a 1:N relation, determining the node generation target table to be the referencing table and a referenced table of the referencing table, and determining the relation frame to be a connecting relation frame that connects a first node of the referencing table and a first node of the referenced table, specifically, the connecting relation frame connects nodes in which data of the column set as a foreign key of the node of the referencing table matches data of a referenced column of the referenced table.

18. The method of claim 1, wherein the determining of the node generation target table and the relation frame for the referencing table comprises, if the relation type of the referencing table is a M:N relation, determining the node generation target table to be a first referenced table of a first constraint of the referencing table, and a second referenced table of a second constraint of the referencing table and determining the relation frame to be a corresponding relation frame that connects a node first of the referenced table of the first constraint of the referencing table and a first node of the referenced table of the second constraint of the referencing table, specifically, the corresponding relation frame connects nodes in which data of a referenced column of the referenced table of the first constraint of the referencing table matches data of a referenced column of the referenced table of the second constraint of the referencing table.

19. The method of claim 1, wherein the determining of the node generation target table and the relation frame for the referencing table comprises, if the relation type of the referencing table is a M:N relation, if the referencing table is referenced by a second referencing table, and if the relation type of the second referencing table is a 1:N relation, determining the node generation target table to be a first referenced table of a first constraint of the referencing table, a second referenced table of a second constraint of the referencing table, and determining the relation frame to comprise a first relation frame and a second relation frame, wherein:
the first relation frame connects a first node of the first referenced table and a first node of the referencing table, specifically, the relation frame connects nodes in which data of a first referenced column of the first referenced table matches data of a first referencing column of the first constraint of the referencing table, and
the second relation frame connects a second node of the second referenced table and a second node of the referencing table, specifically, the relation frame connects nodes in which data of a second referenced column of the second referenced matches data of a second referencing column of the second constraint of the referencing table.

20. The method of claim 1, wherein the determining of the node generation target table and the relation frame for the referencing table comprises, if the relation type of the referencing table is a parallel relation, determining the node generation target table to be the referencing table and a referenced table of the referencing table, and determining the relation frame to comprise a first relation frame and a second relation frame, wherein:
the first relation frame connects a first node of the referenced table and a first node of a first referencing table of a first constraint of the referencing table, specifically, the relation frame connects nodes in which data of a first referenced column of the referenced table matches data of a first primary key column of the first referencing table of the first constraint of the referencing table, and
the second relation frame connects a second node of the referenced table and a second node of a second referencing table of a second constraint of the referencing table, specifically, the relation frame connects nodes in which data of a second referenced column of the referenced table matches data of a second primary key column of the second referencing table of the second constraint of the referencing table.

21. The method of claim 1, wherein the determining of the node generation target table and the relation frame for the referencing table comprises, if the relation type of the referencing table is a reflexive relation, determining the node generation target table to be the referencing table and determining the relation frame to connect a first node and a second node of the referencing table, specifically, the relation frame connects nodes in which data of a first column set as a foreign key of the first node matches data of a primary key column of the second node.

22. A database (DB) migration apparatus comprising:
a constraint collection unit configured to collect a plurality of constraints of a referencing table having a column set as a foreign key, the referencing table being one of a plurality of referencing tables, the plurality of referencing tables being among tables of a relational DB which is a migration source DB;
a relation type determination unit configured to determine a relation type of the referencing table based on the plurality of constraints of the referencing table;
a node and relation determination unit configured to determine a node generation target table and a relation frame for the referencing table based on the relation type of the referencing table; and
a graph DB generation unit configured to convert a plurality of pieces of data in a row of the node generation target table into a node of a graph DB which is a migration target DB, and to generate a relation of the graph DB, which connects the generated node to a plurality of other nodes, according to the relation frame;
wherein the constraint collection unit, the relation type determination unit, the node and relation determination unit, and the graph DB generation unit are implemented via at least one central processing unit (CPU) or at least one hardware processor.

23. A non-transitory computer readable storage medium storing a computer program, said program causing a computer to:
collect a plurality of constraints of referencing table having a column set as a foreign key the referencing table being one of a plurality of referencing tables, and the plurality of referencing tables being among tables of a relational database (DB) which is a migration source DB;
determine a relation type of the referencing table based on the plurality of constraints of the referencing table;
determine a node generation target table and a relation frame for the referencing table based on the relation type of the referencing table; and
convert a plurality of pieces of data in a row of the node generation target table into a node of a graph DB which is a migration target DB, and generate a relation of the graph DB, which connects the generated node to a plurality of other nodes, according to the relation frame.
